(19) United States
(12) Patent Application Publication
(10) Pub. No.: US 2015/0153003 A1
(43) Pub. Date: Jun. 4, 2015

(54) NITRIC OXIDE CYLINDER FILLING APPARATUS AND METHOD

(71) Applicants: J. W. Randolph Miller, Orem, UT (US); John Joseph Miller, Laie, HI (US)

(72) Inventors: J. W. Randolph Miller, Orem, UT (US); John Joseph Miller, Laie, HI (US)

(21) Appl. No.: 14/488,837

(22) Filed: Sep. 17, 2014

Related U.S. Application Data
(60) Provisional application No. 61/878,850, filed on Sep. 17, 2013.

(51) Int. Cl. F17C 5/06; C01B 21/24

(52) U.S. Cl. CPC F17C 5/06; C01B 21/24; F17C 2221/01; F17C 2227/045

(57) ABSTRACT

An apparatus and method for filling a gas cylinder with nitric oxide gas is disclosed. A vacuum pump evacuates the air from the system. A suitable reactor generates nitric oxide gas within the system. The nitric oxide gas fills a gas cylinder. The gas cylinder is pressurized with nitrogen so the nitric oxide gas can be more readily used or stored.

### RELATED APPLICATIONS

This application claims the benefit of U.S. Provisional Patent Application Ser. No. 61/878,850, filed on Sep. 17, 2013, which is hereby incorporated by reference in its entirety.

### BACKGROUND

1. The Field of the Invention

This invention relates generally to filling pressurized gas cylinders, and more specifically to apparatus and methods for generating nitric oxide and filling gas cylinders with nitric oxide gas for storage and use.

2. Background

The discovery of certain nitric oxide effects in live tissue garnered a Nobel prize. Much of the work in determining the mechanisms for implementing, and the effects of, nitric oxide administration are reported in literature. In its application however, introduction of nitric oxide to the human body has traditionally been extremely expensive. The therapies, compositions, preparations, hardware, and controls are sufficiently complex, large, and expensive to inhibit more widespread use of such therapies. One cause of the expense it's the difficulty in creation, purifying, and pressurizing of nitric oxide.

What is needed is a comparatively simple, easily controlled, and consequently inexpensive mechanism for generating nitric oxide and filling pressurized gas cylinders with nitric oxide for easy storage and use of nitric oxide. Also needed is a simple method for operating the system for filling gas cylinders with nitric oxide.

### BRIEF SUMMARY OF THE INVENTION

In accordance with the foregoing, certain embodiments of apparatus and methods in accordance with the invention provide a system that produces nitric oxide for filling a gas cylinder. Nitric oxide in a gas cylinder may then be stored or used as considered needed and appropriate. Nitric oxide amounts may be generated and stored at a therapeutically effective amount on the order of a comparatively low hundreds (e.g., 100-500) of parts per million, or in thousands of parts per million.

For example, the entire system for filling gas cylinders with nitric oxide may be placed under vacuum. Nitric oxide is generated in any suitable manner. The nitric oxide is then stored in a gas cylinder. The nitric oxide in the gas cylinder can be stored under pressure with nitrogen.

One embodiment of an apparatus and method in accordance with the present invention may rely on a small reactor and a system of filters, pumps, and cylinders configured to produce and contain nitric oxide in a gas cylinder. Other embodiments may provide for filling of multiple cylinders with nitric oxide. Other embodiments may provide for analysis and delivery of the nitric oxide generated and contained in a gas cylinder.

Reactors for producing nitric oxide may be configured in a variety of ways, such as reactors using heat from various sources to initiate a reaction. The reactor may preferably contain a chemically stable composition for generating nitric oxide. Reactive compounds for producing nitric oxide may be appropriately combined in various forms, such as solid, liquid, gel, or any combination thereof. Reactants may include potassium nitrite, sodium nitrite or the like. The reaction may begin upon introduction of heat.

Such reactors and reactant compositions, along with their formulation techniques, shapes, processes, and the like are disclosed in U.S. Pat. No. 7,220,393, and U.S. Pat. No. 7,939,045, U.S. patent application Ser. No. 12/361,123, U.S. Pat. No. 8,434,475, U.S. Pat. No. 8,501,090, U.S. patent application Ser. No. 12/419,123, and U.S. patent application Ser. No. 13/197,695, all incorporated herein by reference in their entireties as to all that they teach.

In certain embodiments, a vacuum pump is used to evacuate the system before nitric oxide is generated. Also, pressurized cylinders of nitrogen may be used to pressurize nitric oxide cylinders.

In certain embodiments, a system of filters and pumps evacuates air from the reactor and then conducts a controlled flow of nitric oxide out of the reactor. Accordingly, a system may include filters and pumps to evacuate air from the reactor, control production of nitric oxide in the reactor, and conduct nitric oxide out of the reactor. The system may include devices controlling the pumps and the flow of nitric oxide.

The system may be configured for continual use by replenishing the reactants and replacing other components as needed. Alternatively, the system may be completely wrapped in a pre-packaged assembly.

### BRIEF DESCRIPTION OF THE DRAWINGS

The foregoing features of the present invention will become more fully apparent from the following description, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic view of one embodiment of an apparatus in accordance with the invention to generate nitric oxide and fill a gas cylinder with nitric oxide;

FIG. 2 is a schematic view of one embodiment of an apparatus in accordance with the invention to generate nitric oxide and fill a series of gas cylinders with nitric oxide;

FIG. 3 is a schematic view of one embodiment of an apparatus in accordance with the invention to generate nitric oxide, fill a gas cylinder, and analyze and deliver the nitric oxide generated; and

FIG. 4 is a flow chart of one embodiment of a method in accordance with the invention for generating nitric oxide and filling a gas cylinder with nitric oxide.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings.

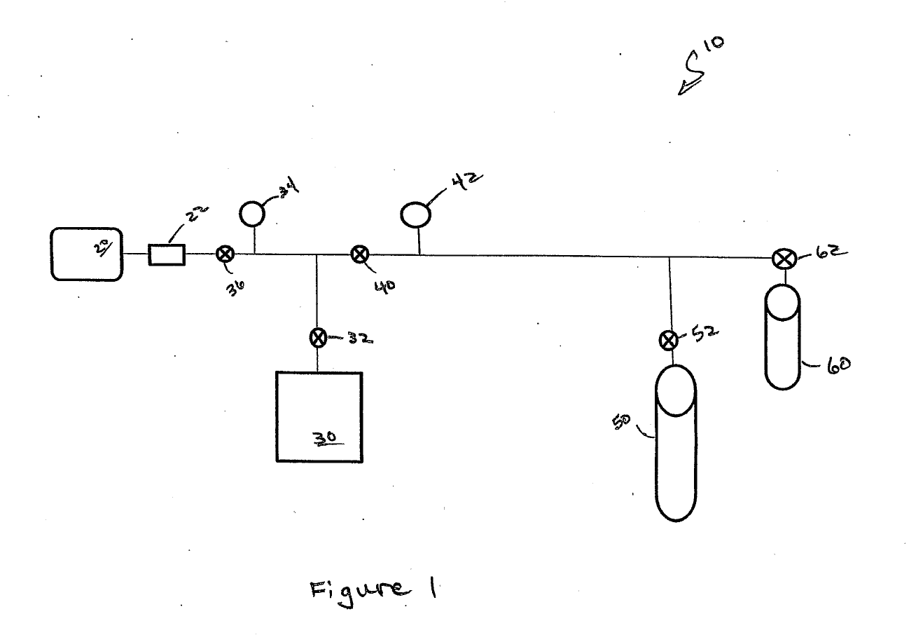

Referring to FIG. 1, a nitric oxide system 10, or system 10, may include a reaction chamber 20, or reactor 20, or generator 20. The reactor 20 provides nitric oxide to be transported to a nitric oxide gas cylinder 60 for storage, use, or both. The reactor 20 may be of any suitable size, shape, or configuration.

The reactor may be in fluid communication with a filter 22. The filter 22 may be a calcium hydroxide filter for trapping moisture and preventing moisture, or other unwanted contaminants or compounds, from entering or leaving the reactor 20. The filter 22 may include other components or compounds suitable for filtering undesirable chemicals, particulates, or the like. The filter may be of any suitable size, shape, or configuration.

The reactor 20 may include reactants capable of producing nitric oxide gas. The reactants may be measured so as to produce a known amount of nitric oxide upon complete reaction. The reactor 20 and the reactants may be configured so as to provide an essentially continuous stream of nitric oxide that can be turned on and off as desired.

The nitric oxide system 10 may include a vacuum pump 30. The vacuum pump 30 may be of any size or configuration capable of creating the intended vacuum. A vacuum valve 32 may be included to provide a means for sealing and opening the system 10 to the vacuum pump 30 as desired. A vacuum gage 34 may be included to provide a means for monitoring the evacuation of air from the system 10 and the creation of a vacuum. Also, a vacuum diaphragm valve 36 may be included to provide a means for controlling the flow of any gasses into or out of the reactor 20. For example and not by way of limitation, in one embodiment, a vacuum diaphragm valve may allow gasses to leave the reactor 20, but not enter the reactor 20 from the remainder of the system 10.

The vacuum pump 30 is in fluid communication with the nitric oxide system 10, including at least a reactor 20, a nitrogen cylinder 50, and a nitric oxide gas cylinder 60. The vacuum pump 30 evacuates gasses and air from the nitric oxide system 10 creating a vacuum throughout the system 10, including without limitation in a reactor 20 and its reaction chamber, a nitric oxide gas cylinder 60, and all the tubing and components between the reactor 20 and the nitric oxide gas cylinder 60.

This vacuum throughout the nitric oxide system 10 is important for preventing nitric oxide generated in the reactor 20 from reacting with any unwanted gasses. For example, nitric oxide may react with oxygen to form nitrogen dioxide. The system 10 should also be kept free of any other contaminants or compounds that may react with the nitric oxide. This will help ensure that pure nitric oxide is stored in the nitric oxide gas cylinder 60.

The nitric oxide system 10 may include a high-pressure shut off valve 40 capable of sealing a reactor 20, and its related components, and a vacuum pump 30, and its related components, from the remainder of the system 10. A high-pressure shut off valve 40 allows for the pressurizing of a nitric oxide gas cylinder 60 without causing any damage to components of the system 10 that may not be able to withstand high pressures, including without limitation a reactor 20 and a vacuum pump 30. The high-pressure shut off valve 40 may be configured to automatically close at a certain pressure to prevent any damage to components of the system 10 that may not be able to withstand high pressures.

The nitric oxide system 10 may include a high-pressure gage 42 to monitor the pressure of the system 10 at any level between zero (0) psi and three thousand (3000) psi.

The nitric oxide system 10 may include a high-pressure nitrogen cylinder 50. The nitrogen cylinder 50 may include a nitrogen valve 52 for controlling the flow of nitrogen into the system 10. The nitrogen cylinder 50 may be used to pressurize a nitric oxide gas cylinder 60 using a gas that will not react with nitric oxide, such as nitrogen. The nitrogen cylinder 50 is in fluid communication with the system 10, including at least in fluid communication with the nitric oxide gas cylinder 60.

The nitric oxide system 10 may include a nitric oxide gas cylinder 60, or NO cylinder 60. The NO cylinder 60 may include a nitric oxide valve 62, or NO valve 62. The NO cylinder 60 may be of any suitable size, shape, and material for storing and using nitric oxide. The NO cylinder 60 may also be pressurized for easier use after the NO cylinder 60 is filled with nitric oxide. The NO cylinder 60 is in fluid communication with the system 10, including at least a reactor 20, a vacuum pump 30, and a nitrogen cylinder 50.

The tubing used for establishing fluid communication between all relevant components of the nitric oxide system 10 may be of any suitable length, diameter and material, including without limitation, stainless steel, rubber, polyethylene, etc. The tubing should be non-reactive and capable of withstanding the pressures required with respect to each connected component of the system 10.

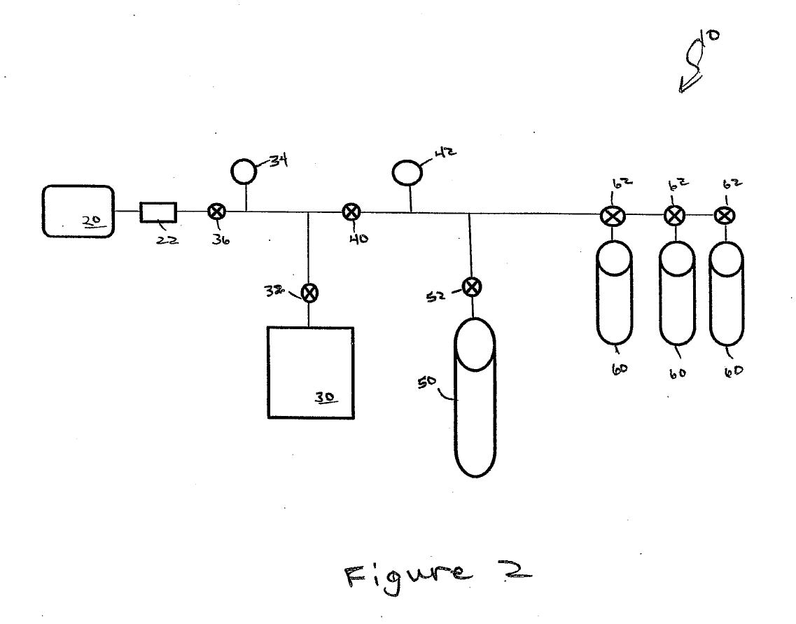

Referring to FIG. 2, a nitric oxide system 10 may include a series of nitric oxide gas cylinders 60 in fluid communication with the system 10. Placing the system 10 under vacuum may include placing any and all NO cylinders 60 connected to the system 10 under vacuum as well. The NO cylinders 60 can be filled simultaneously with nitric oxide generated from a reactor 20.

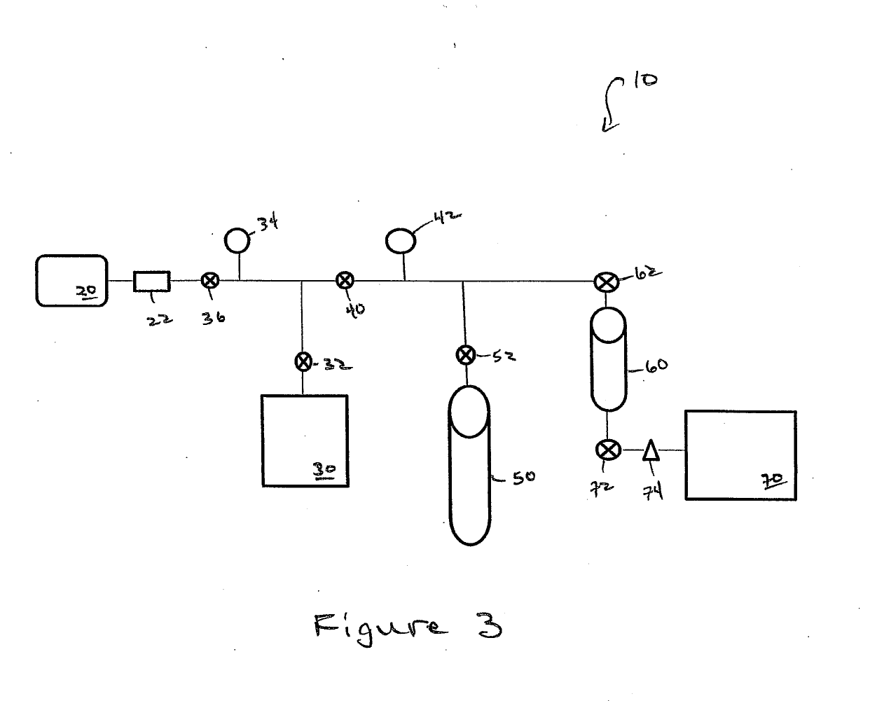

Referring to FIG. 3, a nitric oxide system 10 may include an analyzer 70. The analyzer 70 may be configured to analyze the amount or concentration of nitric oxide available in the NO cylinder 60. The analyzer 70 may be configured to draw or deliver a known and measured concentration of nitric oxide from the NO cylinder 60. The analyzer may include a delivery valve 72 to control the flow of nitric oxide from the NO cylinder 60. The analyzer 70 may also include a regulator 74 to regulate the flow of nitric oxide from the NO cylinder 60 to the analyzer 70.

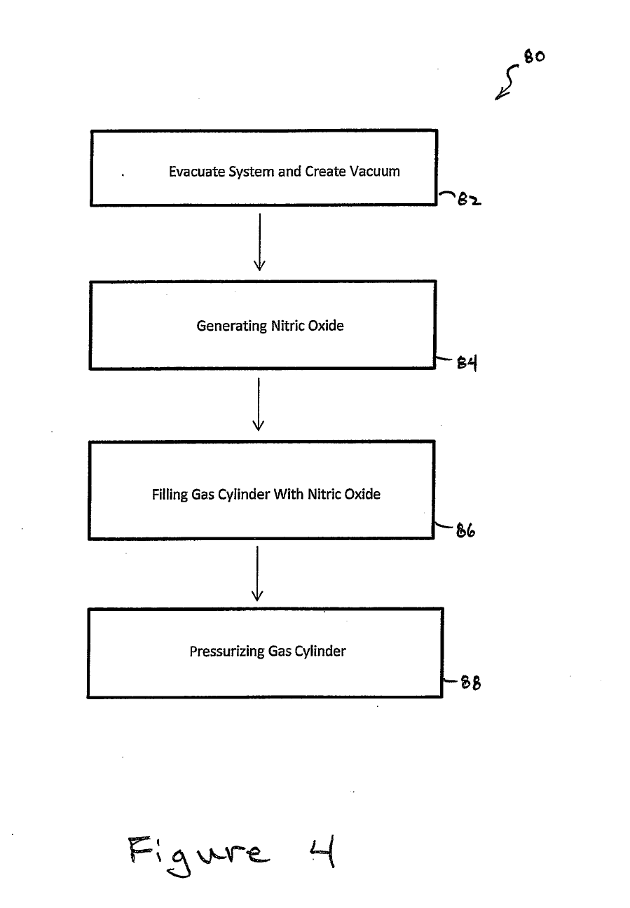

Referring to FIG. 4, a method for filling a gas cylinder with nitric oxide 80 may include the steps of evacuating a system to provide a vacuum 82, generating nitric oxide under vacuum 84, filling a gas cylinder with nitric oxide 86, and pressurizing the gas cylinder 88.

For example, in one embodiment, the nitric oxide system 10 may be placed under vacuum 82. The reactor 20 may be in fluid communication with the rest of the system with the vacuum valve 32 open and the vacuum diaphragm valve 36 open and the high-pressure shut off valve 40 open and the nitrogen valve 52 closed and the nitric oxide valve 62 open and the nitric oxide gas cylinder 60 in fluid communication with the system 10. The vacuum pump 30 may be turned on to evacuate the system 10 of air. Once a vacuum is established in the system 10, the vacuum valve 32 may be closed. The system 10 may then be considered under vacuum.

The reactor 20 may be turned on or initiated to begin the production or generation of nitric oxide gas 84. As will be discussed in more detail, this may be done with the vacuum diaphragm valve 36 either open or closed.

The nitric oxide gas cylinder 60 may be filled with nitric oxide gas 86. As the reactor 20 generates nitric oxide gas, the nitric oxide gas may be allowed to flow into the NO cylinder 60. In one embodiment, the nitric oxide gas may be generated while the vacuum diaphragm valve 36 is closed. This will generate a pressure of nitric oxide gas, which pressure may be measured using the vacuum gage 34. Opening the vacuum diaphragm valve 36 will then allow the built-up nitric oxide gas to enter the NO cylinder 60.

The nitric oxide gas cylinder 60 may be pressurized with nitrogen 88. Once the nitric oxide gas has entered the NO cylinder 60, the high-pressure shut off valve may be closed. The nitrogen valve 52 may be opened to allow the pressurized nitrogen from the high-pressure nitrogen cylinder 50 to pressurize the NO cylinder 60. The resultant pressure of the NO cylinder 60 may be approximately one-thousand eight hundred (1800) psi. The NO cylinder 60 may warm slightly upon pressurization.

Thus, a gas cylinder may be filled with essentially pure nitric oxide and pressured with nitrogen. The resultant NO cylinder 60 may then be used to deliver nitric oxide gas, or used to store the nitric oxide gas for use at a later date.

A substantially identical method can be employed to fill multiple nitric oxide gas cylinders 60 connected to a system 10 in series, as shown in FIG. 2.

In one embodiment, the nitric oxide system 10 can be flushed with nitrogen from the nitrogen cylinder 50 before evacuating the system 10 and establishing a vacuum. The nitrogen may clear any reactants undesirable in the system 10 prior to establishing a vacuum and prior to generating any nitric oxide.

There are various techniques that may be employed to fill a nitric oxide gas cylinder 60 with a known quantity of nitric oxide gas. One technique may be employed or a combination of techniques may also be employed. For example, a known quantity of reactants may be used in the reactor 20 so that a known quantity of resultant nitric oxide gas is provided to the NO cylinder 60. Also, a known quantity of produced nitric oxide gas may be evenly distributed between NO cylinders 60 connected to the system 10 in a series.

Another technique for determining the amount or concentration of nitric oxide gas in a nitric oxide gas cylinder 60 may include weighing the NO cylinder 60 before and after filling.

Another technique for determining the amount or concentration of nitric oxide gas in a nitric oxide gas cylinder 60 may include controlling the temperature of the reactor 20.

Another technique for determining the amount or concentration of nitric oxide gas in a nitric oxide gas cylinder 60 may include any suitable analysis using a nitric oxide analyzer to determine the concentration of nitric oxide gas in a NO cylinder 60.

Another technique for filling a nitric oxide gas cylinder 60 with a known quantity of nitric oxide gas may include generating the nitric oxide gas in an evacuated system with the vacuum diaphragm valve 36 closed to allow a pressure of nitric oxide gas to build up between the reactor 20 and the vacuum diaphragm valve 36. Then, a known quantity of nitric oxide gas can be delivered to the NO cylinder 60 by allowing a known drop in the pressure behind the vacuum diaphragm valve, for example, a drop from ten (10) psi to zero (0) psi.

Accordingly, in one embodiment of the method for filling a nitric oxide gas cylinder 60 with nitric oxide gas, a known quantity of nitric oxide gas can be delivered to the NO cylinder 60 by allowing a known drop in the pressure behind the vacuum diaphragm valve. For example, a total drop in pressure of one (1) psi was shown to deliver approximately 30-60 ppm of nitric oxide gas to the NO cylinder 60. For another example, a total drop in pressure of fifteen (15) psi was shown to deliver approximately fourteen-thousand (14,000) ppm of nitric oxide gas to the NO cylinder 60. Thus, a wide range of nitric oxide gas concentrations can be delivered to the NO cylinder 60 using a wide variety of techniques.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A method for filling a gas cylinder with nitric oxide, comprising:
providing a system comprising:
a reactor, a pump, and a nitric oxide cylinder all in fluid communication with each other, wherein the reactor is capable of generating nitric oxide gas and the pump is capable of establishing a vacuum throughout the system and the nitric oxide cylinder is capable of containing the nitric oxide gas generated by the reactor;
a vacuum valve is proximate the pump and positioned within the system in a manner that allows the pump to be closed off from the remainder of the system;
a vacuum diaphragm valve is proximate the reactor and positioned within the system in a manner that allows the reactor to be closed off from the remainder of the system;
creating a vacuum within the system;
closing the vacuum valve;
generating nitric oxide gas; and
filling the nitric oxide cylinder with the nitric oxide gas.

2. The method of claim 1 wherein the system further comprises a filter proximate the reactor and positioned within the system so that gasses passing in and out of the reactor pass through the filter.

3. The method of claim 2 wherein the system further comprises an analyzer in fluid communication with the nitric oxide cylinder.

4. The method of claim 1 wherein the system further comprises at least two nitric oxide cylinders that are in fluid communication with the system.

5. A method for filling a gas cylinder with nitric oxide comprising:
providing a system comprising:
a reactor, a pump, a nitrogen cylinder, and a nitric oxide cylinder all in fluid communication with each other, wherein the reactor is capable of generating nitric oxide gas and the pump is capable of establishing a vacuum throughout the system and the nitrogen cylinder is capable of providing nitrogen gas and the nitric oxide cylinder is capable of containing the nitric oxide gas generated by the reactor;
a vacuum valve is proximate the pump and positioned within the system in a manner that allows the pump to be closed off from the remainder of the system;
a vacuum diaphragm valve is proximate the reactor and positioned within the system in a manner that allows the reactor to be closed off from the remainder of the system;
a nitrogen valve is proximate the nitrogen cylinder and positioned within the system in a manner that allows the nitrogen cylinder to be closed off from the remainder of the system;
a nitric oxide valve is proximate the nitric oxide cylinder and positioned within the system in a manner that allows the nitric oxide cylinder to be closed off from the remainder of the system; and
a high-pressure shut-off valve positioned within the system in a manner that allows the reactor and the pump to be closed off from the nitrogen cylinder and the nitric oxide cylinder;
creating a vacuum within the system;
closing the vacuum valve;
generating nitric oxide gas;
filling the nitric oxide cylinder with the nitric oxide gas; and
pressurizing the nitric oxide cylinder using the nitrogen cylinder.

6. The method of claim 5 further comprising:
flushing the system with nitrogen prior to creating the vacuum.

7. The method of claim 6 wherein the system further comprises a vacuum gauge positioned within the system to allow monitoring the vacuum within the system and a high-pressure gauge positioned within the system to allow monitoring a high pressure within the system.

8. The method of claim 7 wherein the system further comprises a filter proximate the reactor and positioned within the system so that gasses passing in and out of the reactor pass through the filter.

9. The method of claim 8 wherein the system further comprises an analyzer in fluid communication with the nitric oxide cylinder.

10. The method of claim 9 wherein the nitric oxide gas within the nitric oxide cylinder is substantially pure.

11. The method of claim 8 wherein the nitric oxide cylinder is filled with a known quantity of nitric oxide gas based on a known amount of reactants used to generate the nitric oxide gas.

12. The method of claim 8 wherein the nitric oxide cylinder is filled with a known quantity of nitric oxide gas by generating the nitric oxide gas in the system with the vacuum diaphragm valve closed to allow a pressure of nitric oxide gas to build up between the reactor and the vacuum diaphragm valve and then allowing a known drop in the nitric oxide gas pressure.

13. The method of claim 5 wherein the system further comprises at least two nitric oxide cylinders that are in fluid communication with the system.

14. The method of claim 8 wherein the system further comprises at least two nitric oxide cylinders that are in fluid communication with the system.

15. An apparatus for filling a cylinder with nitric oxide gas comprising:
a reactor, a pump, a nitrogen cylinder, and a nitric oxide cylinder all in fluid communication with each other, wherein the reactor is capable of generating nitric oxide gas and the pump is capable of establishing a vacuum throughout the apparatus and the nitrogen cylinder is capable of providing nitrogen gas and the nitric oxide cylinder is capable of containing the nitric oxide gas generated by the reactor;
a vacuum valve is proximate the pump and positioned within the apparatus in a manner that allows the pump to be closed off from the remainder of the apparatus;
a vacuum diaphragm valve is proximate the reactor and positioned within the apparatus in a manner that allows the reactor to be closed off from the remainder of the apparatus;
a nitrogen valve is proximate the nitrogen cylinder and positioned within the apparatus in a manner that allows the nitrogen cylinder to be closed off from the remainder of the apparatus;
a nitric oxide valve is proximate the nitric oxide cylinder and positioned within the apparatus in a manner that allows the nitric oxide cylinder to be closed off from the remainder of the apparatus; and
a high-pressure shut-off valve positioned within the apparatus in a manner that allows the reactor and the pump to be closed off from the nitrogen cylinder and the nitric oxide cylinder.

16. The apparatus of claim 15 further comprising a filter proximate the reactor.

17. The apparatus of claim 16 further comprising a vacuum gauge positioned within the apparatus to allow monitoring the vacuum within the apparatus.

18. The apparatus of claim 17 further comprising a high-pressure gauge positioned within the apparatus to allow monitoring a high pressure within the apparatus.

19. The apparatus of claim 18 further comprising an analyzer in fluid communication with the nitric oxide cylinder.

20. The apparatus of claim 18 further comprising at least two nitric oxide cylinders that are in fluid communication with the apparatus.
